(19) United States
(12) Patent Application Publication
(10) Pub. No.: US 2012/0330681 A1
(43) Pub. Date: Dec. 27, 2012

(54) Dynamic vital signs method and apparatus for a physichart system

(76) Inventor: David Babalola Olalekan, Nashville, TN (US)

(21) Appl. No.: 13/507,274

(22) Filed: Jun. 18, 2012

Related U.S. Application Data
(60) Provisional application No. 61/520,837, filed on Jun. 16, 2011.

(51) Int. Cl. G06Q 50/24

(52) U.S. Cl. 705/3

(57) ABSTRACT

A diagnostic medical system management tool that emphasizes local data collection in a global clinical environment to create a cohesive network of computer systems. This invention automates the necessary relationship between caregivers and digital knowledge resources through a functional diagnostic interface.

This specification claims the benefit of provisional patent U.S. 61/520,837 filed Jun. 16, 2011.

### TECHNICAL FIELD

The present invention generally relates to computer based systems and methods that facilitate patient diagnosis and treatment in a healthcare environment.

### BACKGROUND

Medical diagnoses are made by doctors who are limited in their knowledge by many factors. Foremost is their limited capacity to know everything about every medical issue that arises in their practice. Computer based systems provide information to the doctors, but those systems are limited to their own connections, editing, capacity and priorities. Computer based systems generally provide a look at history to understand a present condition. However, history is made with every present condition—whether it is a statistical reinforcement that increases confidence in the historical consensus, or statistical anomalies that lead to misdiagnoses and can harm a patient.

It would be desirable to have a computer system of medical treatment that considered these and other pertinent factors as it generated a medical treatment plan.

### SUMMARY

The following presents a simplified summary of the specification in order to provide a basic understanding of some aspects of the specification, not an extensive overview of the specification. It is intended to neither identify key or critical elements of the specification nor delineate any scope particular embodiments of the specification, or any scope of the claims. Its sole purpose is to present some concepts of the specification in a simplified form as a prelude to the more detailed description that is presented later.

A method and apparatus are presented herein that can be subcomponents of a Physichart system. As used in this specification, Physichart is an electronic medical records management system.

In an embodiment, a client vital signs method reads a user/caregiver evaluation of a patient through collecting history, physical examination and recording vital signs. The method calculates derived values such as Body Mass Index (BMI).

The method establishes a set of normal values for readings and derived values. The method establishes a set of patient specific normal values for readings and derived values. The method establishes a set of demographic normal values for readings and derived values. The method displays new values only after confirmation. The method saves new values after confirmation.

The method compares each value with database of published normals such as the World Health Organization (WHO) and Center for Disease Prevention and Containment (CDC) publications. The method inserts the three sets of normal values into electronic chart. The method identifies abnormal values. The method communicates through peripherals. The method alerts the user or other caregiver of abnormal values, alerts emergency contacts of dangerously abnormal values, and suggests next treatment steps for abnormal values.

The method compares the user entered data to the stored International Classification of Diseases (ICD) table and makes a likely diagnosis. The method also provides alternative diagnoses and presents those diagnoses and alternatives from the stored ICD table to the user. The method reads user selection and designation of client provisional diagnosis, and then makes the client provisional diagnosis available to a server. The method saves the client provisional diagnosis to memory.

In an embodiment the client vital signs method can be part of a system of methods that includes a server vital signs method for developing and storing a facility profile for each of many client facilities, and providing this information to other server and client components for use and storage.

In an embodiment communication among the components, computers, caregivers and peripherals is facilitated using interne protocols or hardwiring, and is configured to accommodate existing communication technologies.

### BRIEF DESCRIPTION OF THE DRAWINGS

FIG. 1 is an illustration of a patient vital signs component flow diagram of an exemplary method, 100, that can be performed by a computer.

FIG. 2 is an illustration of the computers, 200, in an exemplary Physichart system.

FIG. 3 is an illustration of server component blocks and connections, 300, of an exemplary Physichart system.

FIG. 4 is an illustration of component blocks and connections of medical data sources, 400, in an exemplary Physichart system.

FIG. 5 is an illustration of the computers, 500, in an exemplary Physichart system.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of this innovation. It may be evident, however, that the innovation can be practiced without these specific details. In other instances, well-known structures and devices are shown in block diagram form in order to facilitate describing the innovation.

The subject disclosure presents one, or a set of software components operating in server and client computer systems. In an embodiment, these components intake patient data, intake medical opinions, intake medical observations, intake medical data from medical sources, intake client facility information, and use that information to create patient management instructions, present those results for the user and make information available for storage regarding each use of the system as a transaction.

As used in this specification, a client computer system can be owned and operated by a hospital, a school, a laboratory, a library, a government institution, a standards institution, a solo medical practice, a group medical practice, an outpatient clinic, a pharmacy, an individual such as a student or researcher, a political organization, a news reporting organization, clinical research operation, salesperson or other person interested in the Physichart system.

In an embodiment, communication among the server and clients can be facilitated using the internet. HTTP and secure HTTPS protocols can be used to provide communications from Physichart systems to allow access to client system memory. FTP protocols can be used to provide communications from the client system to limit access to Physichart memory. Access by other protocols and other means are comprehended to facilitate communications such as hardwiring any combination of the sources, manager systems, server, client and peripherals.

As used in this specification, patient data can be read from a variety of sources. This includes recording vital signs. This includes the patient giving information through computerized interviews. This includes diagnostic measurements taken by healthcare providers such as nurses, technicians, laboratories, and doctors. Such diagnostic measurements include those made using tools such as blood pressure cuffs, thermometers, and other traditional means whose results are read and recorded by hand. Recording includes writing or entering to a computer. Such diagnostic measure measurements also includes those made using systems that automatically enter results to a computer such as digital x-ray machines, electronic blood glucometers, and cardiac stress test systems.

Vital signs include for example, blood pressure (BP), respiratory, pulse, temperature, height, weight, oxygen saturation, and pain scale. The method then calculates derived values such as body mass index (BMI) and body surface area. Each of these examples also demonstrate transient, changing values and would be calculated using most current available data. The method records Tmin (minimum recorded body temperature), Tmax (maximum recorded temperature), BPmin (minimum BP), BPmax (maximum BP) for both, diastolic and systolic blood pressures, and time of measurements taken, within a programmable range of time.

As used in this specification, patient data can also include patient histories from a variety of sources. This includes documents scanned into the system or otherwise entered by users. Once entered, patient data can be retained in the Physichart system indefinitely and transferred. Transfer can be made using regulatory compliant methods housed within the components, such as digitized release forms that are signed and scanned as part of a patient's profile.

Patient data can include patient limitations such as other medical conditions, psychological conditions, allergy history, health habits, personality, risk aversion and financial ability to afford the best procedures. Patient data can include other limited patient data such as existing diagnoses, allergy history and epidemiological data.

As used in this specification, medical opinions and observations can include those of the doctors immediately providing treatment and those who provided prior treatment. Medical opinions and observations can also include those made by others. Medical opinions and observations can include other professionals who can contemporaneously review patient diagnostic details remotely using the Physichart system. Medical opinions and observations can also include contemporaneous notes made during treatment, Medical opinions and observations can include historic opinions given about similar patient data, such as prior patient treatment notes, those found in the footnotes of standard medical resources like the Physician's Desk Reference. Medical opinions and observations can be in a variety of forms including free-text notes written by hand, recorded voice notes, scanned documents and those typed directly into the computer systems.

As used in this specification, medical sources can include drug data, procedures data, disease classification data, clinical guidelines data, and government regulations data. In an embodiment, this invention uses the published data of approved medications, medical treatments and procedures, clinical specialty guidelines and prevailing government laws. Medical sources are generally limited to those professionally respected and ethically accepted; however any source can be included. Methods within the system can be used to identify the level of confidence that should be afforded to a source. In an embodiment these data sources are monitored and introduced to the server computer system by human medical data managers.

As used in this specification, a caregiver includes but is not limited to a doctor, nurse, nurse practitioner, physician assistant, technician, friend, family member, emergency responder, or intermeddler providing a medical action to a person.

As used in this specification, client facility information includes the limitations of the environment such as drug formulary, procedures offered, capacity, historic patient census, equipment available, access to other facilities, transportation considerations, weather, employee trends, employee scheduling, and real time status of external resources.

As used in this specification, patient management instructions can include drug, physical intervention, psychological intervention, counseling instructions, spiritual actions, social actions, chronological considerations, immediate actions, short term care, long term care, and automatic notice to other resources.

In an embodiment, a transaction is defined as each use of the system to diagnose a patient, research any topic, enter medical data, or otherwise utilize Physichart. Transactions are stored in memory at the client computer system to provide immediately relevant information and as an archive. Transactions are also stored at the server computer system to provide a comprehensive archive of all Physichart clients.

As used in this specification, information about the transactions can include the patient identity, patient history of conditions, patient history of treatment, patient allergies, patient responses to treatments, patient financial information, patient insurance information, and other patient specific information. Information about the transactions can include the medical diagnosis, the medical information relied upon, the patient information relied upon, the preferred treatment, the actual treatment, the users who provided information during the transaction, and other treatment specific information. Information about the transactions can include times, dates, costs, payments, employees who were involved as caregivers, places where care was provided, facility status information (such as temperatures, humidity, outside weather and utility conditions) and other information specific to the facility providing care.

As used in this specification, reporting and study through other client services components can include the following. Reporting and study can include treatment of patients. Reporting can include financial reports, medical reports, inventory reports, staffing reports, facility operations reports, diagnostic trend reports, statistical reports, quality reports, governmental required reporting, and other reports that utilize the information stored by the Physichart system. Studies can include those by students, institutions, healthcare providers, legislators, salespersons, marketing persons, clinical researchers, and others interested in investigating a particular topic.

The component that is the subject of this specification is a client services component that resides in the client computer system. Client services components can include a discharge summary component, a scheduler component, a clinical images manager component, a coding and billing component, a facility and caregiver manager resource data component, an education and statistics component, a document manager component, a communicator component, and other optional components that would utilize the information provided to improve the healthcare system.

In an embodiment, where there are patient and facility limitations the system can provide both the best standard of care and case-specific alternatives for the particular patient, facility, and the disease or diagnosis. Because Physichart is resident on a server and has a global perspective of multiple facilities, the alternatives can include regional transfer to more capable facilities.

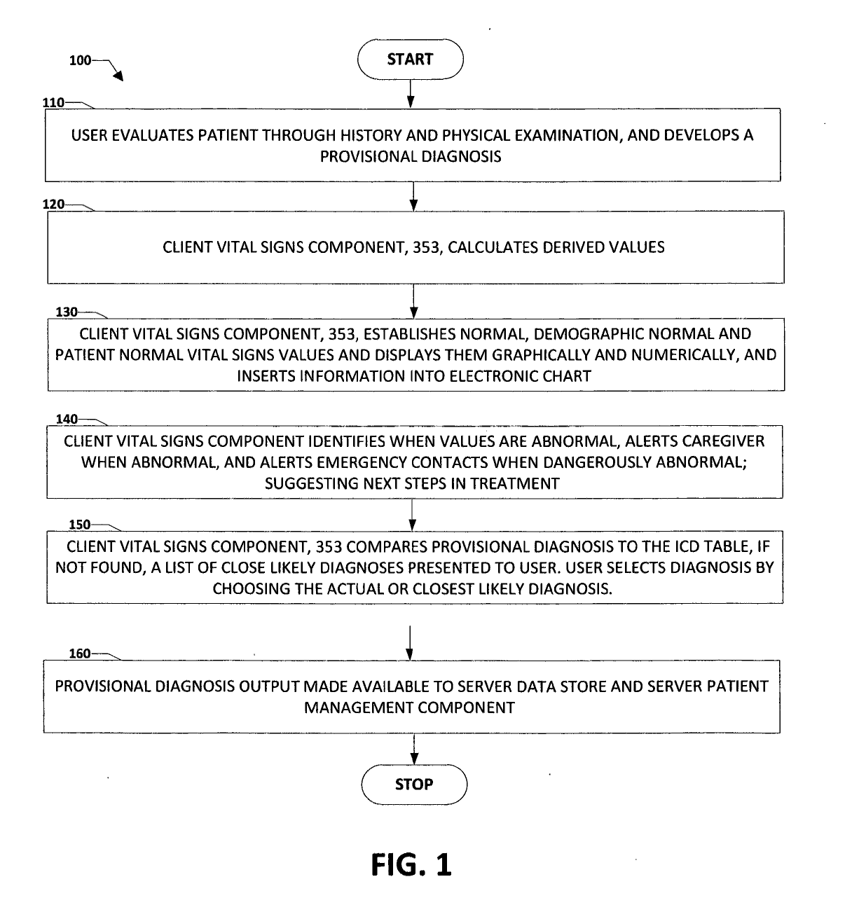

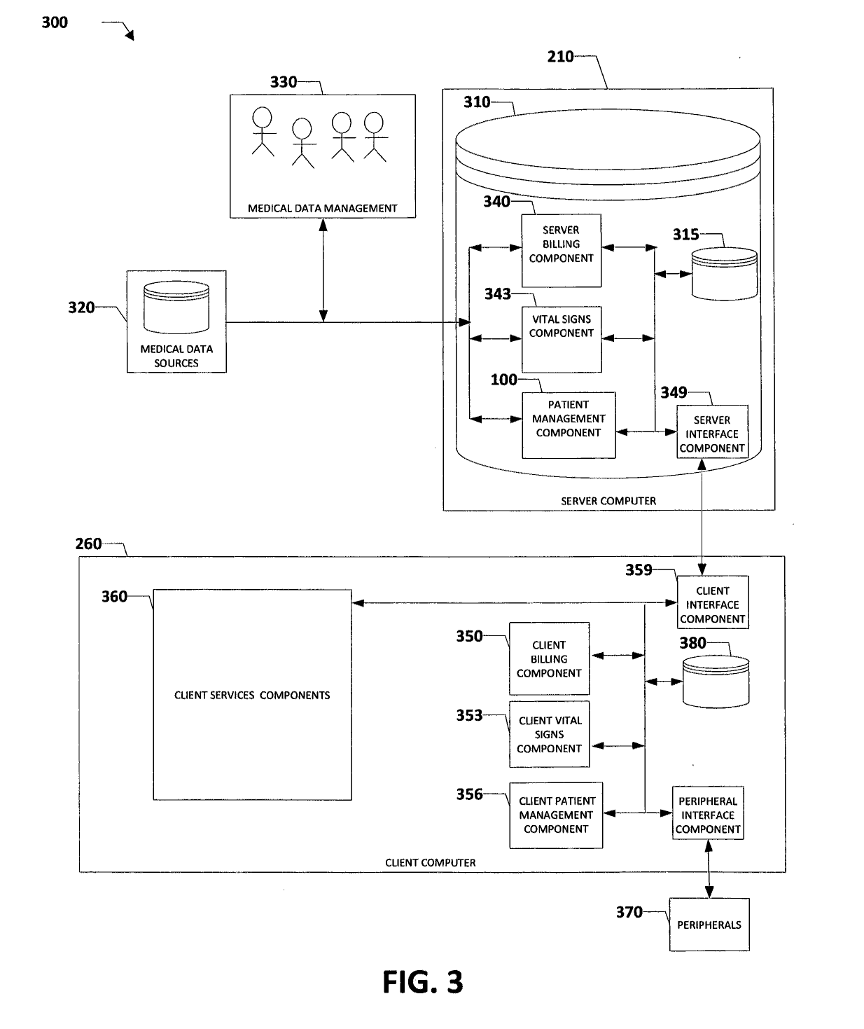

FIG. 1 is an illustration of a patient vital signs component flow diagram of an exemplary method, 100, that can be performed by a computer. At 110, the client vital signs component, 353, a user of the client computer system evaluates a patient through history and physical examination. This evaluation can include reading vital signs. Using the client vital signs output, the user selects a client provisional diagnosis. In an embodiment, the interface uses a profile generated by the server vital signs component, 343, shown also in FIG. 3. The profile includes information about the hospital, regulatory requirements, information about the caregivers, clerical requirements, and other information that makes the system more user friendly and comprehensive of the facility requirements.

The method records Tmin (minimum recorded body temperature), Tmax (maximum recorded temperature), BPmin (minimum BP), BPmax (maximum BP) for both, diastolic and systolic blood pressures, time of measurements taken, within a programmable range of time.

In an embodiment, information security is contemplated in all the transactions made by the computer components, and information is communicated only when allowed by the patient through release forms. The scope of permissions is communicated throughout the client computer components.

At 120, the client vital signs component calculates derived values.

At 130, the client vital signs component establishes normal, demographic normal and patient normal vital signs values; and inserts information into any available electronic charts. Normal values are derived from medical data such as comparing each value with a database of published normals from sources such as World Health Organization (WHO) and Center for Disease Control and Prevention (CDC) publications. As an example, demographic normal values include age, gender, race, and clinical history. Patient normal values include items such as clinical history, diabetes and renal/heart failure. Thus, what is normal for one patient may be abnormal for another.

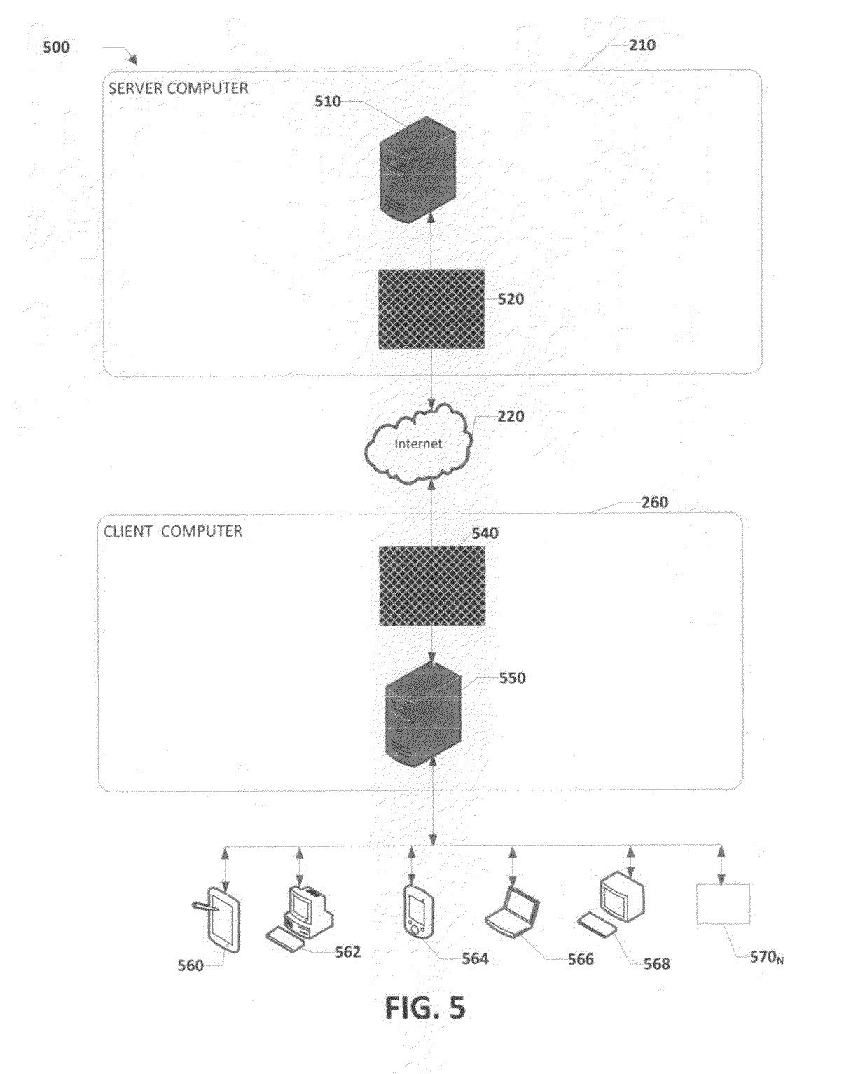

In an embodiment the client vital signs method can display information graphically and numerically. These are programmable options. Information can also be communicated through any of the peripheral devices shown in FIG. 5.

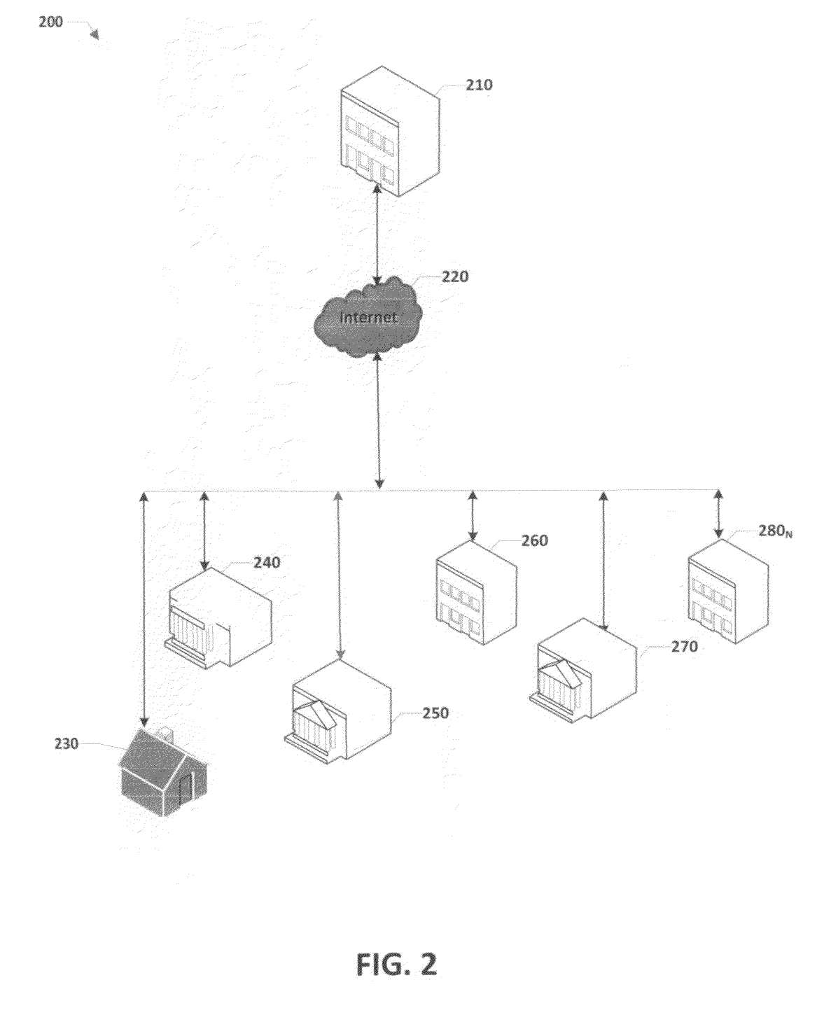

FIG. 2 is an illustration of the facilities and organizations, 200, in an exemplary Physichart system. The Physichart facility is shown as 210. An example of communication with Physichart is shown as interactions on the internet, 220. Communications with the client systems are also shown as interactions with the internet, 220. A solo practice client is shown as 230. An outpatient clinic client is shown as 240. A hospital is shown as 250. A medical practice group is shown as 260. A university system is shown as 270. And multiple other users are shown as 280_{N}, where N is intended to show a finite number of existing possibilities exemplified in this specification.

FIG. 3 is an illustration of server component blocks and connections, 300, of an exemplary Physichart system. A Physichart server system 210 is communicatively coupled to a client system, 260, as shown in FIG. 1 and FIG. 2. The Physichart server system is shown to include server memory, 310. Server memory contains storage and the operational software components. Storage, 315, represents servers within the system of server memory or partitions of memory within a particular storage medium. The transaction history is stored here. Functional copies of the medical data are stored here. Medical data sources, 320, are shown coupled to the server computer and to medical data management, 330. Medical data management is a group of human users with access to the server computer and medical data sources. Medical data managers serve to filter information received from the medical data sources.

The Billing component, 340, resides in the server computer memory. The server billing component reads transaction data stored at 315 to prepare standard reports for the client computer system. The server billing component also prepares standard reports of the transactions for the entire network of clients.

The server vital signs component, 343, resides in the server computer memory, 310. The server vital signs component reads transaction data stored at 315 to prepare a profile for the client vital signs component, 353. The server vital signs component is included in a separate application as a discrete invention.

The server patient management component, 343, resides in the server computer memory, 310. The server patient management component reads transaction data stored at 315 to prepare a profile for the client vital signs component, 353. The server patient management component is included in a separate application as a discrete invention.

The server interface component, 349, manages and facilitates communication between the medical data managers, 330, the client computer systems, 260; and the server computer, 210. The server interface component facilitates communication by reading the output from each of the server and client Physichart component programs and providing input to each of the server and client Physichart component programs. The server interface component is also coupled to the server memory, 315, and is used to create archives by saving and retrieving data. The use of a single server interface component allows Physichart to manage the transactions that occur. It is an important aspect of this invention that it maintains a comprehensive record of transactions. It is this comprehensive record that allows Physichart to improve healthcare on a global basis, for example, as they research, generate reports, prepare more complete medical histories for patients, instantly print a discharge summary, and schedule resources.

The client billing component, 350, resides in the client computer memory. The client billing component reads transaction data stored at 380 and at the server to prepare standard reports for the client computer system.

The client vital signs component, 353, resides in the client computer memory, 310. The client vital signs component operates according to a profile established and stored at the server client vital signs component, 343. The vital signs component is included in a separate application as a discrete invention.

The client patient management component, 353, resides in the client computer memory. The client patient management component reads transaction data stored at the server memory, 315 and client memory, 380 and operates according to a profile established and stored at the server vital signs component, 353. The client patient management component is included in a separate application as a discrete invention.

A client interface component, 359, functions similar to the server interface component, 349, and is resident on the client computer system, 260. The client interface component, 349, manages and facilitates communication between the client computer systems, 260; and the server computer, 210. The server interface component facilitates communication by reading output, and providing input to the server interface component, and the client Physichart component programs. The client interface component is also coupled to the client memory, 380, and is used to create archives by saving and retrieving data. The use of a single client interface component allows Physichart to manage the transactions that occur. It is an important aspect of this invention that it maintains a comprehensive record of client transactions just as the server maintains a comprehensive record for all clients. It is this comprehensive record that allows the end user to improve healthcare local to the client, for example, as they research, generate reports, prepare more complete medical histories for patients, instantly print a discharge summary, and schedule resources.

In an embodiment, a peripheral interface component is resident in a client computer, 260 and is used to send and receive information between peripherals, 370, and client communication components 350, 353, 356, 360 and 380. Peripherals 370 can include any of the items shown in FIG. 2 as the portable tablet computer, 260; the desktop PC, 262; the smart phone or personal digital assistant, 264; the laptop, 266; the dumb terminal, 268; and multiple other peripheral access devices are shown as 270_{N}, where N is intended to show a finite number of existing possibilities exemplified in this specification.

In an embodiment, client services components, 360, are resident in the client computer memory. The client services components are a series of programs that are discussed in this specification. The client services components read user input, transaction data stored at 380, transaction data stored at the server memory, 315; and processes the information to output combinations of information. These combinations of information are generally useful to improve healthcare by improving communications and making more information available to healthcare providers and researchers.

Client services components can read user input through peripherals, 370. Each client services component is programmed to the provide categories of output. The components can be separated for marketing purposes and for management control.

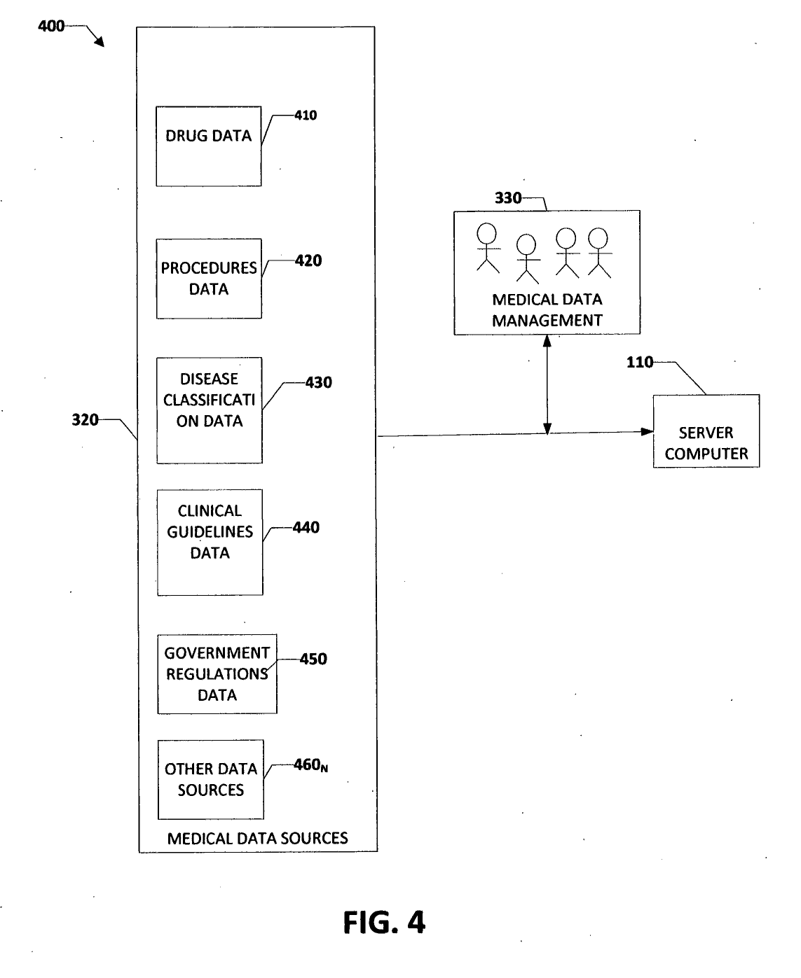

FIG. 4 is an illustration of component blocks and connections of medical data sources, 400, in an exemplary Physichart system. Medical data sources are generated outside of the Physichart system. Medical data sources are physically collected and stored outside of the Physichart systems. For this reason they are shown as being communicatively coupled to medical data management, 330, and the Physichart server computer, 130. Medical data sources can include drug data, 410; procedures data, 420; disease classification data, 430; clinical guidelines data, 440; government regulations data, 450; and other data sources, 460_{N}, where N is intended to show a finite number of existing possibilities exemplified in this specification.

FIG. 5 is an illustration of the computers, 500, in an exemplary Physichart system. The server computer system, 210, and the client computer system 260 are shown connected through the internet, 220. The Physichart computer system, 510 is shown as a single unit however one of ordinary skill in the computer arts would understand that a system of server computers could be used to allow Physichart to operate at a much larger scale. Similarly, the client computer, 550 is shown as a single unit that exemplifies many possible computers used by the client computer system, 260. Likewise, the portable tablet computer, 560; the desktop PC, 562; the smart phone or personal digital assistant, 564; the laptop, 566; the dumb terminal, 568 are shown as individual items but one of ordinary skill in the art of computing would understand that a system of these peripheral access items could include multiple items. Also, multiple other peripheral access devices are shown as 570_{N}, where N is intended to show a finite number of existing possibilities exemplified in this specification.

The aforementioned FIG. 5 items can be communicatively coupled using interactions on the internet, 220. Examples of client facilities include a solo practice, an outpatient clinic, a hospital, a medical practice group, a university system, and multiple other users including a finite number of existing possibilities exemplified in this specification.

One of ordinary skill in the art can appreciate that the various embodiments described herein can be implemented in connection with any computer or other client or server device, which can be deployed as part of a computer network or in a distributed computing environment, and can be connected to any kind of data store where media may be found. In this regard, the various embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the smooth streaming mechanisms as described for various embodiments of this disclosure.

As mentioned above, while exemplary embodiments have been described in connection with various computing devices and network architectures, the underlying concepts may be applied to any network system and any computing device or system in which it is desirable to publish or consume media in a flexible way.

The word “exemplary” is used herein to mean serving as an example, instance, or illustration. For the avoidance of doubt, this matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

Computing devices typically include a variety of media, which can include computer-readable storage media. Computer-readable storage media can be any available storage media that can be accessed by the computer, is typically of a non-transitory nature, and can include both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CDROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables the hardware to perform specific function (e.g., coding and/or decoding); software stored on a computer readable medium; or a combination thereof.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it is to be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described above, methodologies that may be implemented in accordance with the described subject matter will be better appreciated with reference to the flowcharts of the various figures. while for purposes of simplicity of explanation, the methodologies are shown and described as a series of blocks, the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

In addition to the various embodiments described herein, it is to be understood that other similar embodiments can be used or modifications and additions can be made to the described embodiment(s) for performing the same or equivalent function of the corresponding embodiment(s) without deviating there from. Still further, multiple processing chips or multiple devices can share the performance of one or more functions described herein, and similarly, storage can be affected across a plurality of devices. Accordingly, the invention is not to be limited to any single embodiment, but rather can be construed in breadth, spirit and scope in accordance with the appended claims.

As mentioned above, while exemplary embodiments have been described in connection with various computing devices and network architectures, the underlying concepts may be applied to any network system and any computing device or system in which it is desirable to publish or consume media in a flexible way.

The word “exemplary” is used herein to mean serving as an example, instance, or illustration. For the avoidance of doubt, this matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

Computing devices typically include a variety of media, which can include computer-readable storage media. Computer-readable storage media can be any available storage media that can be accessed by the computer, is typically of a non-transitory nature, and can include both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CDROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables the hardware to perform specific function (e.g., coding and/or decoding); software stored on a computer readable medium; or a combination thereof.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it is to be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described above, methodologies that may be implemented in accordance with the described subject matter will be better appreciated with reference to the flowcharts of the various figures. while for purposes of simplicity of explanation, the methodologies are shown and described as a series of blocks, the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

In addition to the various embodiments described herein, it is to be understood that other similar embodiments can be used or modifications and additions can be made to the described embodiment(s) for performing the same or equivalent function of the corresponding embodiment(s) without deviating there from. Still further, multiple processing chips or multiple devices can share the performance of one or more functions described herein, and similarly, storage can be implemented across a plurality of devices. Accordingly, the invention is not to be limited to any single embodiment, but rather can be construed in breadth, spirit and scope in accordance with the appended claims.

What is claimed is:

1. A client vital signs method
Reading a users evaluation of a patient through collecting history, physical examination and recording vital signs,
reading other limited patient data such as existing diagnoses, allergy history and epidemiological data,
calculating derived values
recording Tmin (minimum recorded body temperature), Tmax (maximum recorded temperature), BPmin (minimum BP), BPmax (maximum BP) for both, diastolic and systolic blood pressures, time of measurements taken, within a programmable range of time,
establishing a set of normal values for readings and derived values
establishing a set of patient specific normal values for readings and derived values
establishing a set of demographic normal values for readings and derived values
displaying new values only after confirmation,
saving new values after confirmation
comparing each value with database of published normals (WHO and CDC publications),
inserting the three sets of normal values into electronic chart
identifying abnormal values
communicating through peripherals
alerting caregiver of abnormal values
alerting emergency contacts of dangerously abnormal values
suggesting next treatment steps for abnormal values
comparing user provisional diagnosis to the stored ICD table
providing alternative diagnosis when user provisional diagnosis is not found
presenting diagnosis and alternatives from the stored ICD table to the user
reading user selection and designation of client provisional diagnosis
making the client provisional diagnosis available to a server
saving the client provisional diagnosis to memory as a transaction for study and use by other components.

2. The server vital signs method of claim 1 as part of a system of methods that includes a server vital signs method for developing and storing a facility profile for each of many client facilities, and
providing this information to other server and client components for use and storage.

3. The component of claim 1 wherein communication among the components, computers, caregivers and peripherals is facilitated using internet protocols or hardwiring, and is configured to accommodate existing communication technologies.

4. The component of claim 1 wherein the scope and limits of disclosure of any transactions or information are read from the patient,
saved to memory,
communicated among all of the computer components, and
information is communicated only when allowed by the patient through release forms.

5. A computer having a non-transitory memory device that stores an application program and a processor that executes the following computer executable component steps associated with the application program:
Reading a users evaluation of a patient through collecting history, physical examination and recording vital signs,
reading a user provisional diagnosis
calculating derived values
recording Tmin (minimum recorded body temperature), Tmax (maximum recorded temperature), BPmin (minimum BP), BPmax (maximum BP) for both, diastolic and systolic blood pressures, time of measurements taken, within a programmable range of time,
establishing a set of normal values for readings and derived values
establishing a set of patient specific normal values for readings and derived values
establishing a set of demographic normal values for readings and derived values
displaying new values only after confirmation,
saving new values after confirmation
comparing each value with database of published normals (WHO and CDC publications),
inserting the three sets of normal values into electronic chart
identifying abnormal values
alerting caregiver of abnormal values
alerting emergency contacts of dangerously abnormal values
suggesting next treatment steps for abnormal values
comparing provisional diagnosis to the stored ICD table
providing alternative diagnosis when user provisional diagnosis is not found
presenting diagnosis and alternatives from the stored ICD table to the user
reading user selection and designation of client provisional diagnosis
making the client provisional diagnosis available to a server
saving the client provisional diagnosis to memory.

6. The client vital signs method of claim 5 as part of a system of methods that includes a server vital signs method for developing and storing a facility profile for each of many client facilities, and
providing this information to other server and client components for use and storage.

7. The system of claim 5 wherein communication among the components, computers, caregivers and peripherals is facilitated using internet protocols or hardwiring, and is configured to accommodate existing communication technologies.

8. The component of claim 5 wherein the scope and limits of disclosure are read from the patient,
saved to memory,
communicated among all of the computer components, and
information is communicated only when allowed by the patient through release forms.
